(19) United States
(12) Patent Application Publication
(10) Pub. No.: US 2015/0187211 A1
(43) Pub. Date: Jul. 2, 2015

(54) Method to reduce automobile traffic in a city or in a large city

(71) Applicant: Victor C. Hahn, Roanoke, VA (US)

(72) Inventor: Victor C. Hahn, Roanoke, VA (US)

(21) Appl. No.: 14/121,673

(22) Filed: Oct. 6, 2014

Related U.S. Application Data
(60) Provisional application No. 61/921,218, filed on Dec. 27, 2013.

(51) Int. Cl. G08G 1/00

(52) U.S. Cl. CPC G08G 1/00

(57) ABSTRACT

A method for reducing automobile traffic in a city or in a large city by estimating the Final Destination of commuters that work in the city, as well as by estimating the path (routes) that the commuters take regularly to their Final Destination, by using a computer card to input traffic related data, and a computer to manipulate and analyzed the data from the computer card.

I claim priority over Provisional Patent Application No. 61/961,218

### FIELD OF THE INVENTION

This invention relates, in general, to a (computer) method to reduce automobile traffic in a city, or in a large city, or in a big area; more specifically, to a method to reduce automobile traffic congestions, traffic jams, by gathering (obtaining) relevant traffic related data from “commuters” that in particular, drive automobiles and who work (are employees) in the city, who commute in a regular basis from home to work in the city, and by estimating or determining fairly accurately what the drivers, employees, or commuters (DEC) final destination (FD) is, (ie, home in this particular case), “after” the DEC leave work, as well as, by estimating relevant traffic data from the commuters, like any important roads, intersections, highways that the DEC commuters regularly take to get to their final destination.

In particular, by using a computer capable of reading a computer readable card means/medium for the DEC to input relevant traffic related data (like roads, intersections, entrance/exit roads into a road, entrance/exit name or numbers, highways, zip codes, times, etc,) and, by using a booklet that has instructions and relevant traffic related data from that city like a map of the city, suburbs, names of all relevant (important) roads, intersections, highways, etc, that would guide the DEC in filling out (input) the relevant traffic related data into the computer card/means/medium for the computer to manipulate such data to obtain traffic related results for analysis, inferences, like traffic patterns, traffic routes, traffic flow, by the DEC.

This method can be extended to include commuters that also use Mass Transportation System (MTS) like the Metro and Bus Systems.

The results from the computer, will estimate (or determine) fairly accurately the routes that the DEC commuters take regularly, traffic flows, patterns, heavy traffic flow locations, congestions, therefore, locations were traffic congestions occurs; that is, where many DEC overlap some roads/paths/routes. Therefore, steps to reduce traffic congestion and to improving traffic flow can be made.

Further, many conclusions and recommendations can be made based on the results from the computer to improve present or future planning of new roads, of new highways, widening present roads, modify traffic signals duration, location, etc. These conclusions can also be applied for any present or future type of Mass Transportation Systems (MTS) like for the Metro System or the Bus System, to decrease MTS traffic congestions, therefore, improving traffic flow.

### BACKGROUND OF THE INVENTION

1.0 It is well known that in big cities like in Tyson's Corner located in the suburbs of Washington, D.C., there are many companies or businesses located very close to each other, having therefore a high concentration (density) of employees who most of them drive automobiles to commute to work from home, as there is NO subway yet ending exactly in this particular city, just short by a mile or two. It is also known that some of these DEC also use the MTS in combination to driving, or only MTS, or Bus System; that is, there are basically three types of DEC commuting methods.

These companies (business) are also located very close to some mayor roads, intersections, Highways, like Leesburg Pike (Route 7); the Beltway 495; Interstate I- 66, that many drivers (DEC) use to commute from work to home. It is also know that most employees leave work at about the same time, usually at around 5 pm; (ie, “peak time”), causing traffic congestion(s) specially in relevant roads near where they work.
1.1 In addition, it is also known that most drivers, employees, commuters (DEC) tend to use the same relevant/important/mayor roads, intersections, highways, every day to get home, ie, to get to their final destination (FD), after leaving work in the city, CAUSING the above stated traffic congestions at various relevant roads, intersections, highways, on their way to their FD. Additionally, when DEC try to merge into some relevant/important roads, or highways, like merging into Route 7, or 495, or I-66, they cause the on-going traffic to slow down (congestion) considerably.

Similarly, this method can be extended to include DEC commuters that may also use any type of MTS, like the Metro System or Buss System, that will also cause congestions in some sections or paths or routes of the MTS lines, routes, when the DEC are on their way to their FD, home.
1.2 Its is also know that at the present moment, there is NO method that barely estimates what the final destination of commuters in a city is, nor estimates any or some of the routes (ie, roads, intersections, highways), that the commuters take to their final destination in a regular basis, just perhaps determining the numbers of cars going through a selected road per time of the day, after some equipment or lines are installed across a road. Therefore, The present invention presents new method to “gather” this relevant traffic data from commuters via a computer card/means that is analyzed by a computer, that will estimate fairly accurately their routes connecting work to their final destination, (ie, some their “paths”). Any “overlapping” of routes would indicate traffic congestions for recommendations. The results will also help to plan present and future Mass Transportation Systems, accordingly.

Similarly (or vice versa), the above stated traffic congestions, jams, back ups, also occurs when commuters (DEC) that live in the suburbs, leave home in the mornings to get to work in the city. Therefore, the present method of this invention can be reversed to commuters that live in the suburbs, to estimate or determine “WHAT” their FD in the city “is”, ie, “where” do they work in the city, and “what” the relevant roads, intersections, highways the commuters (DEC) take to their FD in the city.

### SUMMARY OF THE INVENTION

2.0 It is an object of the present invention to reduce automobile traffic congestion, traffic jams, in some roads or main roads, some intersections or main intersections, some highways, access roads and exit roads to highways or to roads, caused by commuters (DEC) in a city or in a large city, or in a large area, in particular, after the commuters leave work.
2.1 It is also an object of the present invention to determine or estimate fairly accurately what the Final destination (FD) of commuters (DEC) “is” after they leave work, as well as to estimate (or determine) some of the relevant roads, intersections, or highways, (ie, paths, routes) that the commuters take in a regular daily basis to get to their FD. Further, some secondary roads, intersections, access roads and exit roads to relevant roads, intersections, or highways, can also be estimated or determined.
2.2 It is an object of this invention to have a COMPUTER capable of reading and of manipulating traffic related data gathered (obtained) from the DEC in a city or in a large city, for traffic related calculations, analysis, inferences, that would determine or estimate traffic flows, patterns, routes, etc, taken by the DEC on their way to their FD (home). The results will help to estimate where any traffic congestion will occur, that would allow to make inferences to reduce traffic congestions. The congestion(s) should occur in some sections (paths) of routes, like roads, highways, etc, that many DEC take at about the same time, ie routes that many DEC “overlap” with each other.

More specifically, the computer can estimate the theoretical (or obvious) path/routes that the DEC take to get to their FD, ie, the obvious paths that connects the work location to their final destination, that would show the overlapped paths/routes.
2.2.1 The computer has memory storage capability to store all relevant traffic related data like in a “traffic related database”.
2.3 It is also an object of this invention to have a computer readable card/means/medium in which the DEC can input relevant traffic related data.
2.4, The computer has a computer program capable of “reading” and manipulating or processing the traffic related data from the computer readable card/medium to produce traffic results.
2.5, It is an object of this invention to have (use) a BOOKLET (or a pamphlet, or similar means) that has instructions to guide the DEC in how to input relevant traffic related data into the computer card/means/medium.
2.5.1, The booklet (or pamphlet) can have or has a MAP of the city or of the large city that has all relevant roads, main roads, intersections, highways, location of relevant companies, business, housing areas, etc. The map can further include the location of High Density Living Areas (HDLA) like high rise apartment buildings, complex apartments, housing areas, in particular the location of large companies or corporations like an automobile plant, that will cause traffic congestions.

The booklet (or map) CAN also have the ZIP codes of the city, or of the large city. The map can also be designed according to any advance knowledge of any traffic patterns before given to a certain group of DEC, like a given company or a given area of the city.

Further, some ZIP codes can be divided into SMALLER zip codes for more accuracy if needed, like in areas where many DEC are located/concentrated, like an area where many companies are located, or a large company is located, or in a large housing area, or a high rise building(s), etc, that are sources of traffic.
2.5.2 Furthermore, for more accuracy, the map can have some sections/areas of the city or large city, mapped and labeled with vertical and horizontal lines so that each square can have a smaller designation for accuracy to better estimate or determine the Point of Origin (PofO), ie, work location, and/or the FD of the commuters.
2.6, The cards can have a CODE, like (1) a single code, like a number, a color, or the date handed out, or (2), more than one code, like a number and a color, or the date handed out and a color, or two colors, etc. Another advantage of the present invention of adding a code(s) to the cards, like numbers from 1 to nth, would be to determine the percentage of returned cards given out to the DEC in a given location/company. An advantage of using different colors would be to use different colors for different companies or for different areas, etc. Also, code(s) could detect if more than one card is returned by a single DEC commuter.

Code(s) would also help when the present invention is being implementation in the field (real world) for the first time, like to determine how the DEC would respond to disclose and input their personal traffic related data in the computer cards. Another advantage of the present invention is the fact that minimal or no personal information is disclosed by the DEC in the cards, basically ONLY the DEC's home zip code, but zip codes generally cover a fairly large area with many commuters, drivers; therefore, the home zip code should have no effect, and the DEC should consider his traffic data almost 100% anonymous.

Names and home address are not requested because they are NOT relevant to determine traffic patterns, flows, congestions that are caused by automobiles. This method therefore respect privacy of the DEC that should “increase”the “response” by the DEC, that is important to estimate as close as possible the real traffic flow, patterns, final destinations, the DEC routes from work to their FD, congestion points, etc. Privacy represents a real “advantage” of the present invention.

To give more confidentiality to the DEC to disclose their personal traveling routes or data, specially the zip code of their FD where they live, each zip codes can state the “approximate” number of DEC that drive automobile in that zip code; another advantage of the present invention.
2.7 The booklet can also have additional traffic related data for those DEC that may also use any type of Mass Transportation System (MTS) like the Metro System or the Bus System. This additional traffic data would have all Metro Lines, all Metro Stations (for DEC to change and use the Metro System or Buss System), Metro Transfer Stations to another Metro Line (or to the Bus System), as well as all the Bus Routes, Bus Stops, Bus Transfer Stations, etc.
2.8, therefore, the present invention can fairly accurately estimate or determine the path/routes/roads, traveled by ALL types of DEC (commuters) from work to their FD, to closely represent the real world of commuters in the city or in the large city.
2.9, In another object of this invention, or in another “embodiment” of the invention, a method to estimate or determine fairly accurate (1) what the FD of commuters (DEC) in a selected area or large demographic area (hereby called PofO) is, and (2) what of some of the paths, routes, roads, intersections, highways (PRRH) that the DEC take from the PofO to their FD is, by (3) gathering traffic related data from the DEC to input into the Computer Readable Card/means/medium, and by having the “computer” read and manipulate these traffic related data to obtain traffic results, like to estimate the FD, the relevant routes, roads. intersections, highways, that the DEC take from their PofO to their FD, that is, the routes connecting these two points, and determine traffic patterns, flows, congestion points. The results would also show where most commuters live.

The sections of routes that most DEC take at about the same time, (ie, paths/routes overlapped), can be considered as a congestion point(s); therefore, inferences to reduce congestion can be done.
2.10, It is still another object of this invention to GATHER (obtain) relevant traffic related data from the DEC (in the city) to “input” into the computer readable card/means, like names of relevant roads, intersections, highways, entrance name or number to a given road or highway, or when exiting them; zip codes, MTS Systems like the Metro System including all Metro Lines and Stations, Transfer Stations, as well as from the Bus System, like all Bus Routes, Bus Stops, Transfer Stations, etc, that some DEC may take when commuting to their FD. For example:
[1] First, Computer Cards and Booklets are given to “each” DEC in a company in the city,
[2] The DEC inputs the number of employees that work in this particular company/location in the card,
[3] the time that the DEC usually leaves work every day, and the time the DEC usually arrives at his FD (ie, home),
[4] then, the DEC can input the Zip Code where the DEC works, and the Zip Code of his FD, (home),
[5] if the DEC rents or own a home, or lives in a complex apartment; (note: homeowners will most likely take the same roads for years to come),
[6] then, DEC can input in the card if they “drive”, or drives and uses “Mass Transportation System” (MTS), or only Mass Transportation System,
[7] then, the DEC can input the relevant roads, intersections, main intersections, highways, names or numbers of any entrance or exit road to any relevant roads, intersections, highways, etc, that the DEC regularly takes to his FD, (using the booklet, map, etc, as reference, guidance),
[8] The times the DEC arrives and/or exits at any of these relevant traffic points. (This information can determine how heavy (congestion) or slow traffic is between work (PofO) to the FD, or between any two traffic points, if the time between any two points is too much, and where and how important would it be to reduce traffic between any 2 or more traffic points. This time calculations and observations can also be applied to the traffic data obtained form the MTS commuters,
[9] It is an objective of this invention that once the DEC and MTS commuters have completed filling out (input) the traffic related data into the computer readable card/means, the commuters can “drop off” the computer card at work, or at any public mail box, or in an special box in any post office, or any similar simple method; (this is another advantage of the present invention versus the prior art, if any; ie, privacy of who the DEC is and/or lives while disclosing relevant, personal traffic data).

Further, in another case, MTS commuters that “are traveling”in a section of a given Metro Line that is known to have heavy traffic, (that is, while the commuters are actually in the Metro System commuting where the traffic is heavy), can be requested to pick up a Booklet and a Computer Readable Card to fill out, in order to determine where do they “work (PofO)”, and what their FD “is”. This could confirm, to a good extend, results from the above cases, and still estimate traffic flow/routes, traffic patterns.

Vice versa, the present method stated in section 2.0 (or in another embodiment of the present invention), can be “reversed”for commuters (DEC) that live in the suburbs, like in Tyson's Corner or in Manassas, and commute to downtown Washington, DC. In this case then, the PofO would be any city in the suburbs, and the FD would be in downtown Washington, D.C. Then, the path/routes, traffic patterns, traffic flows, congestion of sections of routes “overlapped”by many DEC, can be estimated by the computer. (As stated above, many companies and/or business are located in DC, but now the congestion(s) would be in the “opposite”direction”, and early in the morning while the DEC go to work, vs. after the DEC leave work late in the day.) It would be very relevant (important) to see how these two different traffic flow patterns, congestions, that are in “different” directions, would look like, and to compare them to see which one is worse. But, in theory, they are basically for the SAME commuters (DEC).
3.0, THE COMPUTER is capable to store a MAP of the city or of a large city, (also stated in section 2.5.1, 2.5.2), with all the relevant traffic related data from the city, suburbs, or of the large city, in the “traffic related database”, in order to manipulate/process that data with the data gathered from the DEC, and perform calculations. Again, the data stored in the “database” can include ALL relevant roads, intersections, highways, locations of companies, housing areas, HDLA, zip codes; distances between any relevant traffic points, in other words, as if having “actual”distances between any two relevant traffic point in the city, large city, or large area, like distances between intersections, between any intersection to any relevant highway entrance or exit; company to company distances, for calculations, analysis, etc, ie, basically “all data”gathered regarding the city and all data gathered from the DEC commuters. More specifically, like:
   distances from any company (or from the DEC) to all relevant roads, intersections, highways, specially the nearest ones that the DEC will most likely take right after leaving work,
   the number of lanes in each road, in each highways, through any relevant intersection,
   the maximum and the normal number of cars that can travel (in either direction) along any relevant road, intersection, highway, bridges, as well as per time of the day if possible, as well as in any section of a road, or block of a road, section of a highway, road or highway entrance or exit roads,
   location of all relevant traffic signals, the sequence of the signals, the duration of the signal,
   distances from any zip code to any other zip code (if by using the “center” of the area covered by the zip code as a “reference point” for calculation purposes with other zip codes);
   location of all the companies, business, of large housing areas like high rise apartments buildings, HDLA, etc.

Similarly, the computer can also store in the “database”all relevant traffic related data regarding all types of Mass Transportation Systems (MTS) like (1) from all Metro Lines and their Routes, Stations, Transfer Stations, and (2) from all Bus Lines and their Routes, Bus Stops; all Buss Transfer Stations including to a Metro Line, so that ALL the routes, roads, etc, traveled by all the different types of commuters can be estimated (determined) fairly accurately by the computer in the present invention, and therefore, estimate fairly accurately traffic patterns, flows, and estimate as close as possible were actual congestions occur in the field/real world.
4.0, Computer Calculations, Analysis:

It is still another object of this invention to have the COMPUTER “perform” calculations, analysis, (ie, to manipulate/process the traffic related data), based on the data inputted from the computer cards/medium from the DEC, in addition to the traffic related data from the city and suburbs stored in the computer “database.

For example, the computer can “estimate” (or determine) fairly accurately, the route or roads that “each” DEC most likely takes from work to his FD, and what the various “sections” of routes or roads that many DEC “overlap” with each other in any relevant road(s), highway(s), intersection(s), at about the same time, as well as the “number” of DEC “overlapping” these routes, roads, (paths). (Note that the computer can (1) estimates arrival times at any relevant traffic point as the computer knows the time that each DEC leaves/left work, and/or (2) the arrival times at any traffic point(s) based in the arrival time(s) given by the DEC in the computer card/means.)

The analysis can determine/estimate when any congestion would start to form as a function of time, its peak time, the duration of the congestion, and vice versa, how the congestion would decrease back to normal traffic as a function of time.

Again, Considering a simple case when the computer only knows an additional one, or two, or even three traffic points in addition of knowing the 2 zip codes of work and of the FD, like knowing a relevant intersection(s), or a relevant route(s), or a relevant highway(s) , or an entrance/exit road to a highway, or any arrival or exit time to a traffic point, then the “computer can still estimate”the route or path most likely traveled by the DEC, as well as where any “overlap” or congestion would occur. This means that the computer method in the present invention is still very accurate for practical purposes, even when a few traffic points are given/known.

Further, some “basic calculations”that the computer can perform (or estimate) are: average velocities by the DEC between any two relevant traffic point of a road, of a highway; between two intersections, (note: average velocities requires to know distances and the times between 2 points, for example, the distance between the zip code from work and the zip code from home, and the times between these 2 point when given in the computer card),
the time spent by each DEC between any two relevant traffic points, like between two points along a road, along a highway, between 2 intersections; (note: arrival times to a traffic point is obtained from the computer card, or can be estimated by the computer when the time that the DEC left work is know; this time(s) would determine the level of congestion if the time is excessive),
total commuting time for each DEC from work (PofO) to their FD;
total distance traveled by each DEC from work (PofO) to their FD, ie, from zip code to zip code
estimate or determine were “most” DEC from a company or “any” section or area of the city, or of the entire city, go to, that is, after estimating/determining their FD by the computer card,
the computer can also estimate the theoretical “average”velocities (that is without traffic) between any two traffic points, and compare these average theoretical velocities with the estimated “average” velocities calculated from the DEC's arrival times at any traffic point, ie, compare the normal average velocity versus the commuting average velocity,
and finally, any additional relevant time and average velocities calculations based on the data gathered from the computer cards, with the data in the computer's database, and with any additional traffic data known from the City Department of Transportation.
5.0 Some Conclusions, Recommendations:
5.1, Based in all of the above results, some additional conclusions that can be made are:
   some drivers (DEC) from a company could be asked to leave work 5, 10, 15, or more minutes apart from a nearby company or companies;
   some DEC from a given company can be asked to take a different road(s) after work to avoid a traffic congestion point estimated by the present invention;
   in a very large company, some DEC from a section in a large building, or DEC from one building close to another building, can be asked to leave work 5, 10, 15, or more minutes apart; therefore, reducing any traffic congestion in the “nearby” relevant roads, intersections, highways, caused when many DEC leave at the same time;
   some DEC can share automobile(s) if some have the same FD Zip code (after asked who lives in that zip code) or a have a very close FD zip code, if the DEC are asked who live in those close zip codes;
   some DEC's with a known same or close FD zip code in the suburbs, can be asked to drive to a given “predetermined” location, specially if they live in a HDLA to take MTS or share automobile,
   traffic lights on/off duration and the sequence of successive traffic lights, can be manipulated in a predetermined manner based on knowing the traffic flow pattern, in order to increase traffic flow (including per time of the day, specially at peak times),
   or other similar obvious conclusions, recommendations based by the results form the present fairly accurately estimated traffic flow pattern from a PofO to a FD,
   all these conclusions, recommendations, can be further complemented and/or combined with any already known relevant traffic related data from the City's Department of Transportation. for better recommendations to reduce traffic congestion.
   similar recommendations, can also be applied to the case of commuters that use Mass Transportation System (MTS) to reduce traffic congestion in the MTS System.

### BRIEF DESCRIPTION OF A FLOW CHART

Note: The features described and/or illustrated in the Flow Chart and in FIG. 1, and their format, can also constitute an object of the present invention in their own right, and in any combination of their features thereof.

The following is a very “simple” description of a FLOW CHART explaining a very “SIMPLE” case of DEC in a Company named “ABC” located in Tyson's Corner, near Washington, D.C. shown in FIG. 1, that outlines the 2 main steps of the method of the present invention.
A: Questions asked in the Booklet for the three cases of DEC to Fill out into the Computer Card:

Drives Drives & MTS MTS
Company zip code,
Time that DEC usually leaves work,
First major road, intersection, or highway DEC takes,
Next major road or Highway DEC takes,
Exit Number and/or Name of

Road DEC takes,
Time that DEC usually arrives at this Road Exit
Zip code of Final Destination, ie, home
Time DEC usually arrives at
Final Destination,
B: Data inputted into the computer card by the DEC with an “X” in a box (not shown) regarding the questions asked in A, are shown in FIG. 2.

### BRIEF DESCRIPTION OF THE DRAWINGS:

FIG. 1 is an illustration of the Booklet.

FIG. 2 is an illustration of the Computer Card for the two cases of two different DECs where one DEC only Drives, and the other DEC Drives and uses Mass Transportation System (MTS). The Computer Card shows two columns market with the letter “X” that indicates the answer by each DEC regarding the questions asked above in A. (Note that the Computer Card in FIG. 2 actually represents “two” Computer Cards, one card for each DEC.

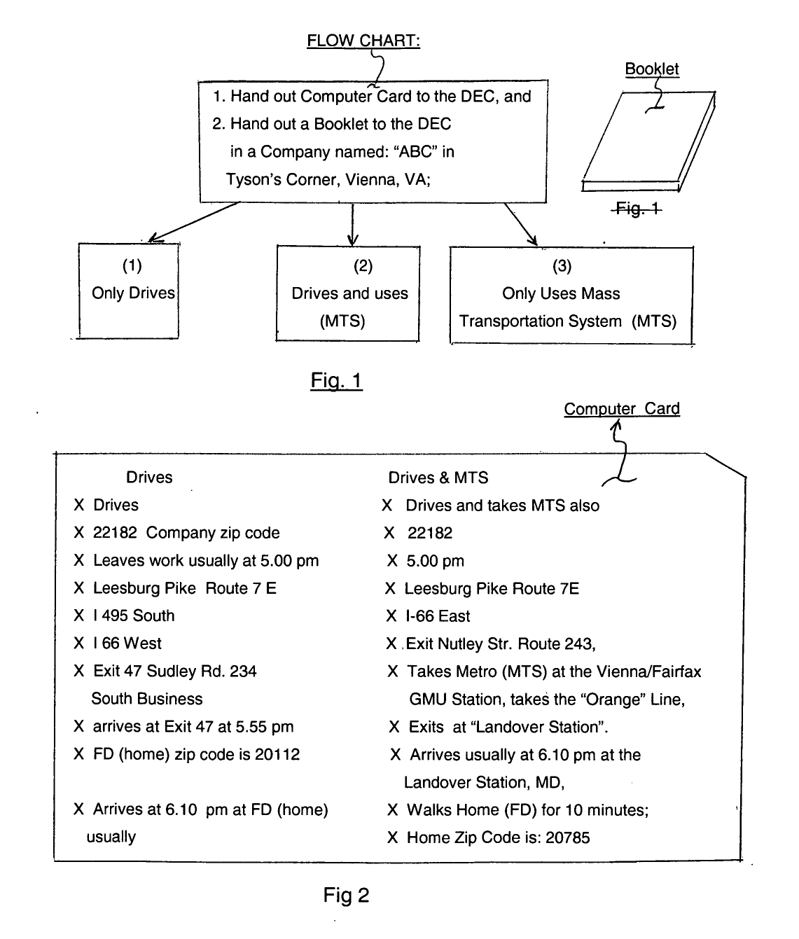

### DETAILED DESCRIPTION OF THE PREFERRED EMBODIMENT

Computer Cards 2 and Booklets 1 are given to ALL employees (DEC) in a Company named “ABC” in Tyson's Corner, Vienna, VA, in the suburbs of Washington, DC, to be fill out as follows:
1, An employee (DEC) states that he “DRIVES”, so he fills out this data (DRIVES) in the computer card 1. Then, the DEC states his zip code is 22182; that he usually leaves at 5 pm, takes Leesburg Pike East, Route 7E; then 1495 South; then 1-66 West; then takes Exit 47 Sudley Rd. 234 South Business; states that his home zip code is 20112, and that arrives at his FD at around 6.10 pm.
2, Another employee (DEC) states that he “DRIVES” first and then takes the “MTS”; that his zip code is 22182, that he leaves usually at 5.00 pm, then, he inputs that he first takes “Leesburg Pike Route 7 East”, then takes 1-66 East, then takes Exit “Nutley Rd. 234 South Business”; then takes the Metro at the “Vienna/Fairfax GMU” Station, and takes the “Orange Line”, then Exits at the “Landover Station, in MD, arrives at this Station at around 6.10 pm, then he walks home for 10 minutes, states that his FD zip code (home) is 20785.

### Planning of Future Roads, Highways, Mts, Recommendations

Further, the results from the computer can help in the study/planning of present, new, and future roads, highways, metros, MTS systems, bridges, any changes to any of them according to what the traffic flow pattern between where most DEC live and where they work is, and location of congestions,
changing traffic directions in any road, highway, relocation of traffic signal, duration of traffic signals based on where any DEC overlap occurs, etc.
It could also help in deciding the proper location in the development and construction of new housing areas, of new high rise buildings, etc, to avoid traffic congestions between any two points/areas in the city with respect where they work,
It could also help in the proper planning/construction of new and “efficient” MTS for fast traffic of DEC from one point to another point in the city knowing present heavy traffic flow patterns by commuters, etc.
7,0 The foregoing description of the invention has been presented for the purpose of illustration and description. The method has been described with regards to a few possible applications of the invention to illustrate the operation thereof. The description is not intended to limit the invention to the precise forms disclosed, however. Consequently, many modifications and variations are possible in light of the above teachings as expressed in the specifications, appended claims, drawings and flow charts,

I Claim:

1, A method for reducing automobile traffic in a city or in a large city by estimating the Final Destination (FD) of commuters, and some of the paths/routes that commuters take regularly to their Final Destination; the method comprising:
(1) a Computer having a computer program and memory storage, and
(2) a Computer readable Card/Means, and
(3) a Booklet that has instructions and traffic related data, wherein, the commuters input traffic related data into the computer readable card/means, the computer reads the computer readable card/means to produce traffic related results for traffic analysis,

2, The method according to claim 1, wherein, the instructions in the booklet guides the commuters in how to input the traffic related data into the computer readable card/means,

3, The method according to claim 1, wherein, the traffic related data in the booklet has a map of the city or of the large city with relevant roads, intersections, highways,

4, The method according to claim 3, wherein, the traffic related data further includes the location of companies and of housing areas,

5, The method according to claim 4, wherein, the traffic related data further includes the zip codes of the city or of the large city,

6, The method according to claim 1, wherein, the booklet can have Mass Transportation Systems (MTS) traffic related data of the city, like of the Metro System and of the Bus System, wherein, the MTS can further include all Metro Lines, Metro Stations, and the Bus System can have all Bus Routes and Buss stations,

7, The method according to claim 6. wherein, the instructions in the booklet can have instructions to guide the MTS in how to input traffic related data into the computer readable card/means,

8, The method according to claim 3, wherein, the computer readable card/means can have a code or more than one code,

9, A COMPUTER method for gathering and for analyzing traffic-related data from commuters in a city for traffic analysis, inferences, and for estimating the Final Destination of commuters and some of the path/routes that the commuters take from a Point of Origin (PofO) to their Final Destination (FD); the method comprising:
(1) a computer having a computer program and memory storage, and
(2) a computer readable card/means, and
(3) a booklet having traffic related data, wherein, the commuters can input traffic related data into the computer readable card/means, the computer reads the data in the computer readable card/means to produce traffic related results for traffic analysis, wherein, the traffic related results can further estimate some of the path/routes traveled by the commuters, and their final destination,

10, The method according to claim 9, wherein, the traffic related data in the booklet has a map of the city with relevant roads, intersections, highways,

11, The method according to claim 10, wherein, the traffic related data further includes the location of companies and of housing areas ,

12, The method according to claim 10, wherein, the booklet can also have Mass Transportation Systems (MTS) traffic related data of the city, like of the Metro System and of the Bus System,

13, The method according to claim 10, wherein, the traffic related data further includes the zip codes of the city.
